(19) United States
(12) Patent Application Publication
(10) Pub. No.: US 2014/0149379 A1
(43) Pub. Date: May 29, 2014

(54) Search Engine Optimization Technique To Obtain Better Webpage Ranking On Major Search Engines

(71) Applicants: James Andreas Hjelming, San Francisco, CA (US); Telemaco Bamabei, San Francisco, CA (US)

(72) Inventors: James Andreas Hjelming, San Francisco, CA (US); Telemaco Bamabei, San Francisco, CA (US)

(73) Assignee: YouInWeb Software Inc., San Francisco, CA (US)

(21) Appl. No.: 13/342,097

(22) Filed: Jan. 1, 2012

(51) Int. Cl. G06F 17/30

(52) U.S. Cl. CPC G06F 17/30864
USPC 707/709; 707/706

(57) ABSTRACT

This system provides a web site with favorable web ranking on a local basis by major search engines. It does this by providing a web page containing the proprietary Question & Answer content section (this is the content section in which this patent will cover). The Q&A section contains content about the business, product(s) and location (city, state) and also contains embedded contextual web links that links to similar content within the same business vertical determined by SIC (Standard Industry Code). These outbound links contains primary keywords that the business wants to obtain optimal ranking and will link other businesses within the same state but not the same city so that direct local area competitors are not linked.

The Q&A content section can be deployed as HTML embedded on a separate web page part of a client's web site, or be hosted by anyone else as a micro site.

A technique to obtain a higher search web page ranking position after a user search query on major search engines for a web page. The invention elevates businesses to top web visibility for local customer searches on leading search engines. It ensures top ranking on search engines for keywords that customers actually use to find local businesses. A questions and answers (Q&A) text content section that enhances the relevance and keyword matching, improving page rank on search engines. The Q&A is built to flag localized relevance for search engines index spiders, but it also provides human readable and formatted content relevant for web consumption. The Q&A section lists ten or more questions about each business. Its purpose is to provide relevant local keywords in the content. The keywords are then substituted for actual web links that link to other pages relevant to the keywords and the proximity to the business.

### BRIEF DESCRIPTION OF THE INVENTION

The purpose with this invention is to automatically build relevant local area pages called micro sites that may be linked to provide a local web visibility service. YouInWeb has generated millions business profile web pages called micro sites that provide the core strength of our web visibility by smart link building strategies.

Every micro site lists local and related business ranked by SIC (Standard Industry Code) and by the count of, incoming links within a specific SIC (Standard Industry Code) category. The technique auto-generates pages for local search relevance, thus achieving top search engine ranking for business relevant keywords within each SIC (Standard Industry Code) category. Since the technique utilizes intelligent link-building strategies as well as highly localized keyword selection within the actual web page content as well as some additional relevance in the regular metadata fields, it is considered to be built on fundamental search indexing/ranking techniques that constitute core weight of search engine ranking algorithms.

Micro sites may also contain a questions and answers (Q&A) text content section that further enhances the localization relevance and keyword matching which improves page rank on search engines. The Q&A is built primarily to flag localized relevance for search engines index spiders, but this section also provides human readable and formatted content relevant for web consumption. The Q&A section lists ten or more questions about each business. Its purpose is to provide relevant local keywords in the content. The technique auto-generates pages for local search relevance, thus achieving top search engine ranking for business relevant keywords within each SIC (Standard Industry Code) category. Since the technique utilizes intelligent link-building strategies as well as highly localized keyword selection within the actual web page content as well as some additional relevance in the regular metadata fields, it is considered to be built on fundamental search indexing/ranking techniques that constitute core weight of search engine ranking algorithms.

### BACKGROUND OF THE INVENTION

Small to medium local businesses frequently have problems using the internet to attract local business because they do not show up on the first search result page, or with Google instant; doesn't come up in the search result very frequently when users enters their query.

The technique solves this by increasing the small/medium business visibility by providing a web page also called micro site powered by several link and text content sections, or the embedment of a questions and answers content section on a business externally hosted web site on the root/index page. This will cause search engines to rank the micro site and the business externally hosted web page on an increased ranking position for a relevant keyword search.

There are several ways to improve page rank positions in the search results however the claimed techniques will further improve page rank positions with major search engines for a web page using the invention.

Obtaining good page rank positions for web pages currently is difficult for small to medium businesses that do not have a high user volume/traffic web site. While there are many Search Engine Optimization techniques to improve page ranking, the invention will further improve page ranking by the generation of relevant keywords and outgoing HTML links. Thus rendering the web page more relevant to search engine results and increasing local visibility.

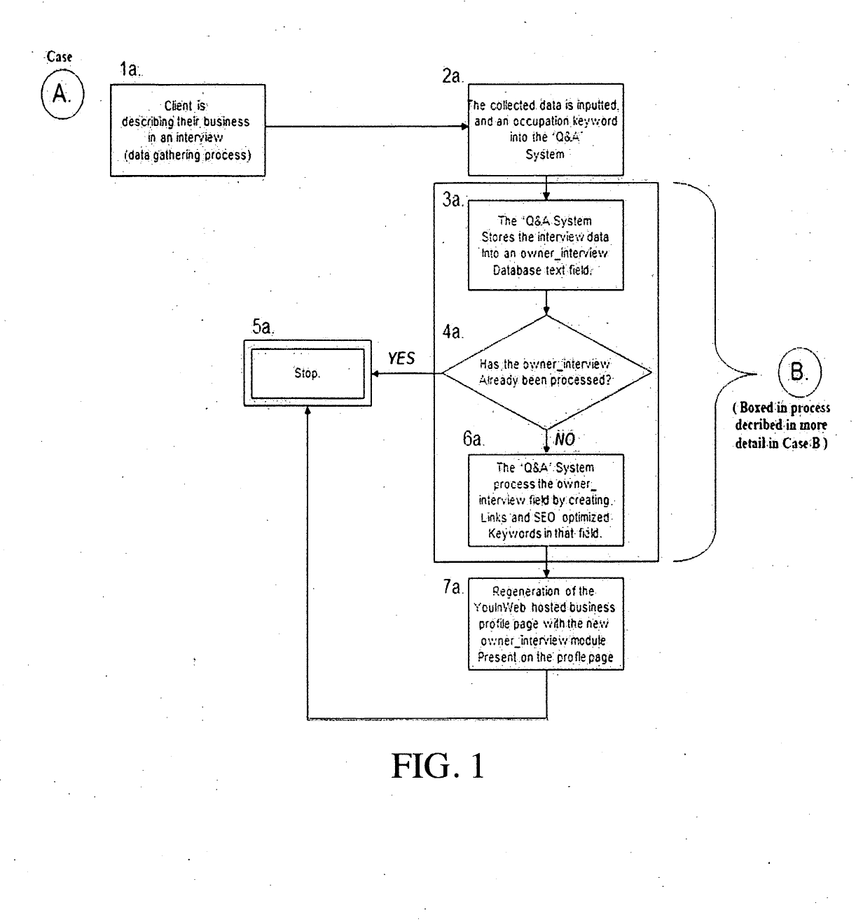

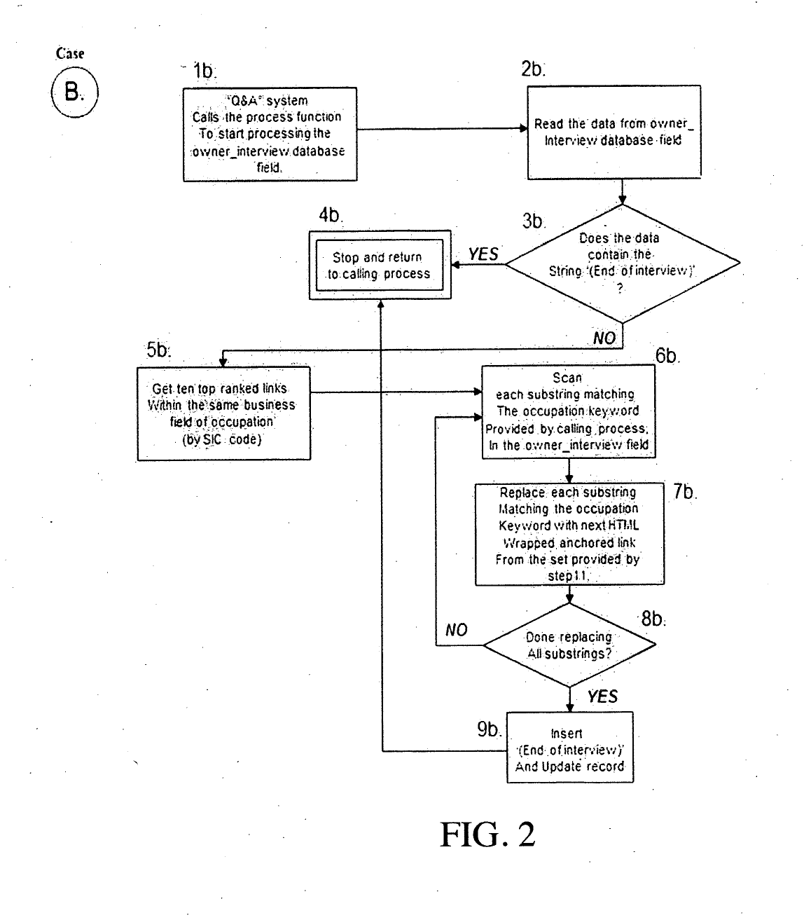

### A BRIEF DESCRIPTION OF THE DRAWINGS

| Reference Number | Name of Step/Decision |
|---|---|
| FIG. 1: | |
| 1a. | Shows the Client interview process |
| 2a. | Shows the Data entry process |
| 3a. | Shows the Data storage step |
| 4a. | Shows the Processing decision |
| 5a. | Shows the Stop (FIG. A) step |
| 6a. | Shows the Main process |
| 7a. | Shows the Regeneration of page process |
| FIG. 2: | |
| 1b. | Shows the Q&A start (Link Generator) process |
| 2b. | Shows the Database field read process |
| 3b. | Shows the End token decision |
| 4b. | Shows the Stop (FIG. B) step |
| 5b. | Shows the ‘Get ten links’ process |
| 6b. | Shows the Start text parsing process |
| 7b. | Shows the Convert keywords to links process |
| 8b. | Shows the Parse loop decision |
| 9b. | Shows the Insert end token process |

### DETAILED DESCRIPTION OF THE INVENTION

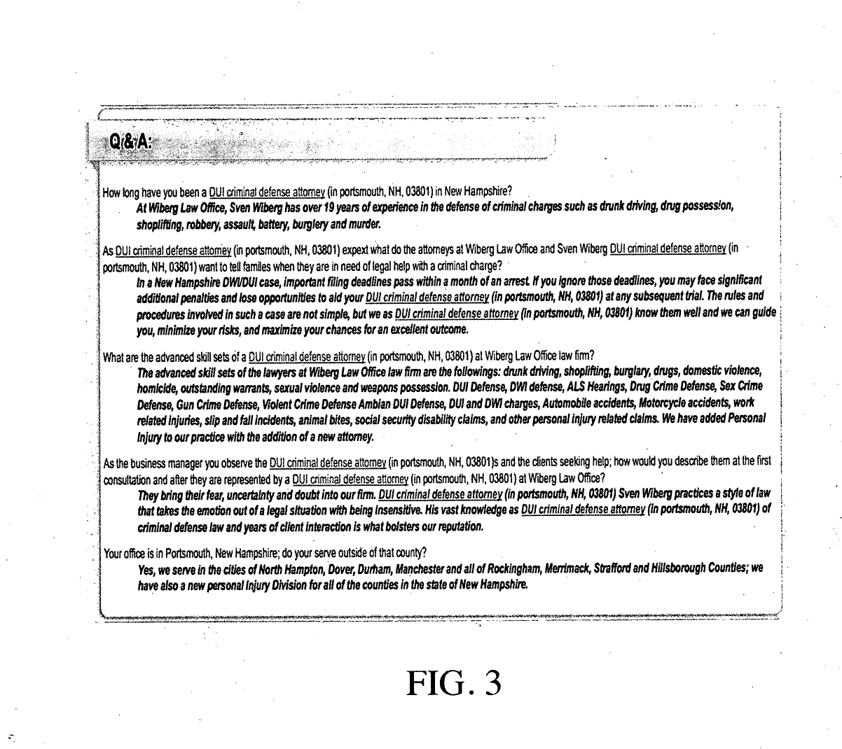

The questions and answers (Q&A) content section shown in FIG. 3 embedded on a web page or micro site will improve the search engine ranking of that web site or micro site. The Q&A system works by scanning the owner interview field for selected keywords, then replacing those keywords with outbound web links to similar micro sites within the area (within the city, then state/province then countrywide). The Q&A system also appends each link with relevant text immediately after each link such as listing the city and ZIP/Postal Code belonging to the business currently being processed. The Q&A system will increase the web page rank position on major search engines such as Bing, Google and Yahoo by increasing relevant keywords on the page as well as specifying the location of the business by repeating the ZIP/Postal Code, city and state/province and thereby increasing the relevance for local search page ranking systems with major search engines. The Q&A system also increases the rank position on major search engines by increasing page links to other micro sites within the network of micro sites and cross domain clients web sites. This network will comprise of intertwined page links that are relevant to the user and communally very important as a Search Engine Optimization technique to obtain improved page ranking positions on major search engines.

The Client interview (1a) step describes the task of collecting information from the client (representative of their business) in the form of an owner interview. It is important to collect relevant information about the client's business and record the owner/representative's occupation as many times during the interview as possible.

The Data entry (2a) step is conducted, storing the owner interview into the “Q&A” system including the business owner's business occupation as a designated occupational keyword. This step then entails adjusting the interview information recorded from the business owner in order to maximize the use of the occupation keyword. It is important that the owner interview is at least one page long and conducted as a process of selling a subscription. In the Data storage step (3a), the “Q&A” system stores the owner interview text into a database text field. The information is stored as soon as the sales representative has finished entering in the owner interview data into the “Q&A” system and clicked on submit using one of YIW servlets. The “Q&A” system will scan the text input field with the owner interview information and then store the scanned text into a database record assigned to the client. The client/business owner's occupational keyword (for example ‘dentist’, ‘attorney’ or ‘retail business’) information is then entered in to the “Q&A” using another text input text field in which the “Q&A’ proceeds to scan that text field and store the data into another database field belonging to that client/business database record.

In the first Processing decision (4a), the “Q&A” system will determine if the owner interview database text field for the current client/business already has been processed before by the system. The “Q&A” system can determine this by scanning the owner interview text for a specific token that indicates the owner interview text has been processed in the past. If it has been processed it will return and flag the operation as complete.

In the Stop step (5a), the process will return control to the user after returning from the “Q&A” system process activities.

In the Main process (6a), the “Q&A” will scan the owner interview text field and look for occupational keywords (provided by sales staff, described in the Data entry (2a) step). Prior to the scan, the “Q&A” system will retrieve ten (or less) anchored HTML links to other subscribed business pages within the same business field, determined by the business SIC (Standard Industry Code). During the scan of the owner interview text field, each time an occupational keyword is found by the “Q&A” system, it will replace that occupational textual keyword, with the immediate next anchored hyperlink (HTML), retrieved by the system prior to the scan. If a keyword has been replaced by the last anchored hyperlink, it will start from the beginning of the set of ten links retrieved prior to the scan, thus the first link is used (then the second etc.). The text part visible on the page within an anchored hyper link will be the same as the give occupational keyword (provided in the Data entry (2a) step).

For example, if the occupational keyword is ‘dentist’, the word ‘dentist’ will be replaced by an anchored hyperlink with ‘dentist’ underlined on the visible profile page as the links visible text. The “Q&A” system will also insert the current business city and zip code within parenthesis immediately after each anchored hyperlink, so that each occupational keyword for the example ‘dentist’ in the city ‘San Francisco’, and zip code ‘94108’ will be replaced with: ‘dentist (in San Francisco, 94108)’ (the underlined dentist word in this example depicts an actual anchored hyperlink to another business profile within the same city or state).

In the Regeneration of page (7a) step, the “Q&A” system will regenerate the profile web page with the updated owner interview module. The regeneration process will entail the generation of a new business profile file (HTML, PHP or some other static or dynamic web front technology) replacing the old file. A database field time stamp for the current business record is also updated at the time of the profile page regeneration.

In the Flow start (1b) step, the “Q&A” system calls the function responsible to process the owner interview database text field.

In the Database field read (2b) step, the “Q&A” system will read the owner interview text field from the database into memory.

In the End token decision (3b) step, the “Q&A” system will scan the read owner interview text string for the end token ‘(End of interview)’. This token indicates whether or not the function should process the owner interview text field or not, depending on if the token is found in the field.

In the Get ten links step (5b), the Q&A system will call the function responsible for retrieving ten or more HTML anchored hyperlinks linking other subscribed micro sites within the same city or state that has the same business SIC (Standard Industry Code). The function will first look for micro sites that are matching within the same city. If less than ten links (or more, depending on the configuration) were found, the database query will expand the query to include the full nation.

In the Start text parsing step (6b), the owner interview field is scanned for the occurrences of the provided occupational keyword (described in the Data entry step (2a)

In the Convert keywords to links step (7b), each occupational keyword is replaced by the next HTML anchored hyperlink (iterative), part of a set of ten or more links which were fetched before the scan.

In the Parse loop decision step (8b), the Q&A system will check if it is time to break the loop by checking if the last occurrence of the occupational keyword (described in the Data entry step (2a)) has been processed.

In the Insert end token (9b) step, the Q&A system will append the end token ‘(End of Interview)’ to the owner interview, ensuring that no owner interview field is processed twice by the Q&A system.

The relationship among the steps and elements including logic and chronological order is shown in both flow diagrams. The process begins at the Client interview step (1a) and ends at the Stop step (5a), while either following the steps in chronological order between the Client interview (1a) and the Stop step (5a), if the Processing decision (4a) is true (yes), thus following the flow to the Stop step (5a). If the Processing decision (4a) is false (no), the flow continues through the steps from the Processing decision (4a) skipping the stop step (5a) to Regeneration of page (7a), then flowing from Regeneration of page (7a) directly back to the Stop step (5a). The relationship between the Data storage step (3a), the Processing decision (4a) and the Main process (6a) flow of logic is further depicted in detail in diagram B.

The relationship among elements in diagram B is that of chronological logic flow from the Q&A system start (1b) to the End token decision (3b). If the End token decision (3b) answer is true (yes), processing will stop at (4b), otherwise it will flow from the Get ten links (5b) step to the Insert end token (9b). The elements from the Start text parsing (6b) to the Parse loop decision (8b) will keep iterating until the Parse loop decision (8b) answer is true (yes).

What is claimed is:

1. A computer-implemented method of obtaining top local area page ranking on major search engines for business web sites with the objective to become visible for local customers using search engines to find local services, comprising:
a large network of custom machine built and distributed business “micro sites” also called business profile web pages spanning most cities and larger areas in the country each representing a business, comprising:
a special section of each micro site to increase local area page ranking from major search engines by providing pre-calculated html links to other micro sites within the network;
a special section listing multiple local and related micro site links, including their individual address, city and state;
an outbound html link from to the external web site hosted by the business.

2. A computer-implemented method of obtaining top local area page ranking on major search engines for “white-labeled” client business external hosted web sites with the objective to increase page ranking on search engines, comprising:
an embedded special content section according to claim 12 within the first root page of the domain.

3. A computer-implemented method of obtaining top local area page ranking on major search engines according to claim 1, wherein the micro site is optimized by local area keywords.

4. A computer-implemented method of obtaining top local area page ranking on major search engines according to claim 1, wherein the micro site is optimized for local area outbound links to other Youinweb hosted micro sites.

5. A computer-implemented method of obtaining top local area page ranking on major search engines according to claim 1, wherein the micro site is linked back, aka inbound link from the business external hosted web site.

6. A computer-implemented method of obtaining top local area page ranking on major search engines according to claim 1, wherein the micro site has been fully populated with relevant local business text content.

7. A computer-implemented method of obtaining top local area page ranking on major search engines according to claim 1, wherein the micro site has been fully populated with relevant business video content.

8. A computer-implemented method of obtaining top local area page ranking on major search engines according to claim 1, wherein the micro site has been fully populated with relevant business image content.

9. A computer-implemented method of obtaining top local area page ranking on major search engines according to claim 1, wherein search engines index spider will scan each micro site for keywords and link relevance provided by each special content section so that search engines will assign high local area ranking for each ranked micro site.

10. A computer-implemented method of obtaining top local area page ranking on major search engines according to claim 1, wherein search engines index spider will scan each micro site for keywords and link relevance provided by each special content section so that search engines will increase the local area ranking for each business external hosted web site by the provision of an inbound html link from the highly content relevant micro site to the business external hosted web site.

11. A computer-implemented method of obtaining top local area page ranking on major search engines according to claim 1, wherein for white-label clients search engines index spider will scan each business external hosted web site for keywords and link relevance provided by the special content questions and answers section according to claim 12, so that search engines will increase the local area ranking for each business external hosted web site.

12. A special questions and answers content section for top local ranking placements by search engines, comprising:
multiple text paragraphs with multiple questions and answers about the featured business;
single or multiple outbound links embedded in each question and answer, comprising:
each html link points to another micro site within local proximity by ZIP or Postal Code and/or within the same SIC (Standard Industry Code);
each html link contains business selected keywords within its text field;
each html link follows with the text content of the city location of the business;
each html link follows with the text content of the state/province of the business;
each html link follows with the text content of the zip/postal code of the business;

13. A special questions and answers section on each micro site for top local ranking placements by search engines according to claim 12, wherein the questions and answers are as a whole section distinctly unique for each micro site.

14. A special questions and answers section on each micro site for top local ranking placements by search engines according to claim 12, wherein search engine spiders matches keywords from the text content for each individual search query.

15. A special questions and answers section on each micro site for top local ranking placements by search engines according to claim 12, wherein search engine spiders matches keywords from the html link for each individual search query.

16. The section according to claim 12, wherein the questions and answers section is embedded within a business external website without a corresponding micro site generated for that business.

17. The section according to claim 12, wherein the questions and answers section is embedded within a business external website and some of the questions and answers html links also links to other business external web sites with their own domain.

18. A special local and related businesses content section contained within each micro site for top local ranking placements by search engines, comprising:
Two columned sections, each listing either local by ZIP code or related by SIC (Standard Industry Code) other micro sites, comprising:
each html link points to another micro site within local proximity by ZIP or Postal Code and/or within the same SIC (Standard Industry Code);
each html link contains the business name within its text field;
each html link follows with the text content of the city location of the business micro site;
each html link also follows with the text content of the state/province of the micro site;
each html link also follows with the text content of the zip/postal code of the micro site;
each html link also follows with brief text content description of the linked micro site.

19. The section according to claim 18, wherein the special local and related businesses content section is embedded in white-labeled clients business external hosted web sites on the root page of the domain, in order to increase page rank generated from the search engine spiders collected data.

20. The section according to claim 18, wherein the special local and related businesses content section also contains links to other external hosted web sites in addition to other micro sites, thereby creating a link network that spans cross domain.

21. A special image map section contained within each micro site for general web user consumption, comprising:
Two vertical sections, comprising:
the city grid map, showing the exact city grid image location extrapolated by longitude and latitude of the business address;
the street view, showing the street view image of the business address.

22. A network of web links from and to multiple micro sites in order to obtain top local area page ranking on major search engines, comprising:
web links with keywords describing the business in its anchor text field;
web links with the micro site destination selected by ZIP/Postal Code;
web links with the micro site destination selected by SIC (Standard Industry Code);
web links from the Q&A section to externally hosted web sites.
